(19) United States
(12) Patent Application Publication
(10) Pub. No.: US 2019/0152372 A1
(43) Pub. Date: May 23, 2019

(54) PNEUMATIC CONTROL DEVICE FOR VEHICLE SEATS AND PNEUMATIC CONTROL METHOD FOR VEHICLE SEATS

(71) Applicant: AISIN SEIKI KABUSHIKI KAISHA, Kariya-shi, Aichi-ken (JP)

(72) Inventors: Yuki FUJII, Obu-shi (JP); Akiyoshi SHIBATA, Nagoya-shi (JP); Hiroyuki ODA, Hamamatsu-shi (JP); Shunsuke HAYAKAWA, Obu-shi (JP)

(73) Assignee: AISIN SEIKI KABUSHIKI KAISHA, Kariya-shi, Aichi-ken (JP)

(21) Appl. No.: 16/098,048

(22) PCT Filed: Mar. 27, 2017
(86) PCT No.: PCT/JP2017/012483

§ 371 Date: Oct. 31, 2018

(30) Foreign Application Priority Data
May 19, 2016 (JP) 2016-100730

(51) Int. Cl. B60N 2/90; B60N 2/02; A61H 9/00

(52) U.S. Cl. CPC B60N 2/914; B60N 2/0244; B60N 2/976; A61H 9/0078; A61H 2203/0431; A61H 2201/1409; A61H 2201/5007; A61H 2201/0149; A61H 2201/1238

(57) ABSTRACT

A pneumatic control device for a vehicle seat includes a forcible-delivery control unit, an opening-closing control unit, and a residual pressure release control unit. The forcible-delivery control unit drives an air pump to forcibly deliver air to an airbag, which is provided in a seat. The opening-closing control unit opens and closes an inlet valve, which is provided in a passage of the air. The passage is in communication with the airbag. The residual pressure release control unit opens an outlet valve provided in the passage on an upstream side of the inlet valve after driving of the air pump is stopped, thereby releasing the air sealed on the upstream side of the inlet valve in a closed state from the passage.

### TECHNICAL FIELD

The present invention relates to a pneumatic control device for a vehicle seat and a pneumatic control method for a vehicle seat.

### BACKGROUND ART

Patent Document 1 describes an example of a conventional vehicle seat device in which a support shape of the seat can be changed by expanding and contracting airbags (bladders) provided in the seat. In addition, Patent Document 2 describes an example of a seat device in which airbags expand and contract to press the seat covering from the inside. This allows the seat device to give massaging effects to the occupant sitting in the seat.

More specifically, such a seat device drives an air pump to forcibly deliver air so that the airbags provided in the seat expand and contract. In many cases, closing an inlet valve provided in a passage that is in communication with the airbag cuts off the circulation of air through the inlet valve, i.e., the flow of air from the upstream side of the inlet valve toward the airbag and the flow of air from the airbag toward the upstream side of the inlet valve.

### PRIOR ART DOCUMENT

### Patent Documents

Patent Document 1: Japanese Laid-Open Patent Publication No. 2010-235021
Patent Document 2: Japanese Laid-Open Patent Publication No. 2006-198071

### SUMMARY OF THE INVENTION

### Problems that are to be Solved by the Invention

However, in the structures of the conventional techniques, even after the air pump is stopped, the air forcibly delivered from the air pump may be confined, i.e., sealed in the passage on the upstream side of the closed inlet valve. In addition, when the inlet valve is opened, the residual pressure of the air sealed on the upstream side of the inlet valve may instantaneously expand (i.e., budge) the airbag connected to the passage. This may lower the usability for the occupant sitting in the seat. In this regard, there is still room for improvement.

It is an object of the present invention to provide a pneumatic control device for a vehicle seat and a pneumatic control method for a vehicle seat having an excellent usability.

### Means for Solving the Problem

A pneumatic control device for a vehicle seat that achieves the above object includes a forcible-delivery control unit, an opening-closing control unit, and a residual pressure release control unit. The forcible-delivery control unit drives an air pump to forcibly deliver air to an airbag, which is provided in a seat. The opening-closing control unit opens and closes an inlet valve, which is provided in a passage of the air. The passage is in communication with the airbag. The residual pressure release control unit opens an outlet valve provided in the passage on an upstream side of the inlet valve after driving of the air pump is stopped, thereby releasing the air sealed on the upstream side of the inlet valve in a closed state from the passage.

### BRIEF DESCRIPTION OF THE DRAWINGS

FIG. 1 is a perspective view of a vehicle seat provided internally with seat-support airbags.

FIG. 2 is a perspective view of the vehicle seat provided internally with massage airbags.

FIG. 3 is a schematic diagram of a seat device.

FIG. 4 is a flowchart of the procedures for seat-support adjustment control, massage control, and residual pressure release control.

FIG. 5 is a flowchart of the procedures for recognizing the generation of an operation input and holding and updating the content of the operation input during execution of the residual pressure release control.

FIG. 6 is a flowchart of the procedures for the residual pressure release control in a modification.

### EMBODIMENTS OF THE INVENTION

A pneumatic seat device having a seat support function and a massage function and its pneumatic control according to one embodiment will now be described with reference to the drawings.

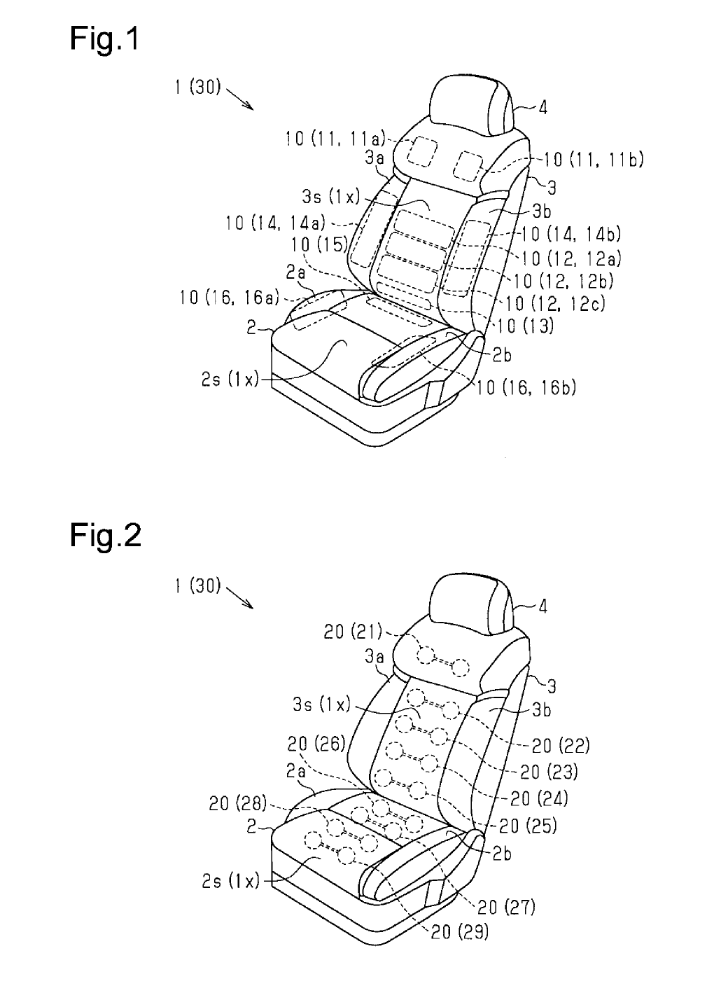

As shown in FIGS. 1 and 2, a vehicle seat 1 includes a seat cushion 2 and a seatback 3, which is provided at the rear end of the seat cushion 2. The upper end of the seatback 3 is provided with a headrest 4.

Further, in the seat 1 of the present embodiment, the seatback 3 is shaped such that two side parts 3a and 3b bulge frontward. In addition, the seat cushion 2 is also shaped such that two side parts 2a and 2b bulge upward. This allows the seat 1 of the present embodiment to ensure a favorable sitting posture of the occupant and keep the sitting posture.

In addition, the seat 1 includes a plurality of airbags 10 (11 to 16) that change the surface shape of the seat 1 by expanding and contracting inside the seat cushion 2 and the seatback 3. Further, the seat 1 includes a plurality of airbags 20 (21 to 29) that press a seat covering 1× from the inside by expanding and contracting inside the seat cushion 2 and the seatback 3 in the same manner. In the present embodiment, this constitutes a seat device 30 capable of changing a support shape of the seat 1 and giving massaging (refreshing) effects to the occupant sitting in the seat 1.

More specifically, the seat 1 of the present embodiment includes independent seat-support airbags 11 (11a, 11b), 12 (12a to 12c), and 13 provided in the seatback 3 at positions corresponding to the shoulder part (shoulder), the waist part (lumbar), and the lower end (back pelvis) of a backrest surface 3s, respectively. Further, independent seat-support airbags 14 (14a, 14b) are provided at positions corresponding to the two side parts 3a and 3b of the seatback 3, respectively. The seat cushion 2 also includes independent seat-support airbags 15 and 16 (16a, 16b) provided in the rear end (cushion pelvis) of a seating surface 2s and in the two side parts 2a and 2b, respectively.

Further, independent massaging (i.e., refreshing) airbags 21 to 25 are provided in the seatback 3 from the shoulder part (shoulder) to the waist part (lumbar) and the lower end (back pelvis) of the backrest surface 3s. The massaging airbags 21 to 25 are arranged in the vertical direction. Each massage airbag 20 in the seat 1 of the present embodiment has a structure in which two bag bodies spaced apart from each other in the width direction of the seat are connected to each other to integrally expand and contact. The seat cushion 2 also includes independent massage airbags 26 to 29 provided below the seating surface 2s. The massaging airbags 26 to 29 are arranged in the front-to-rear direction.

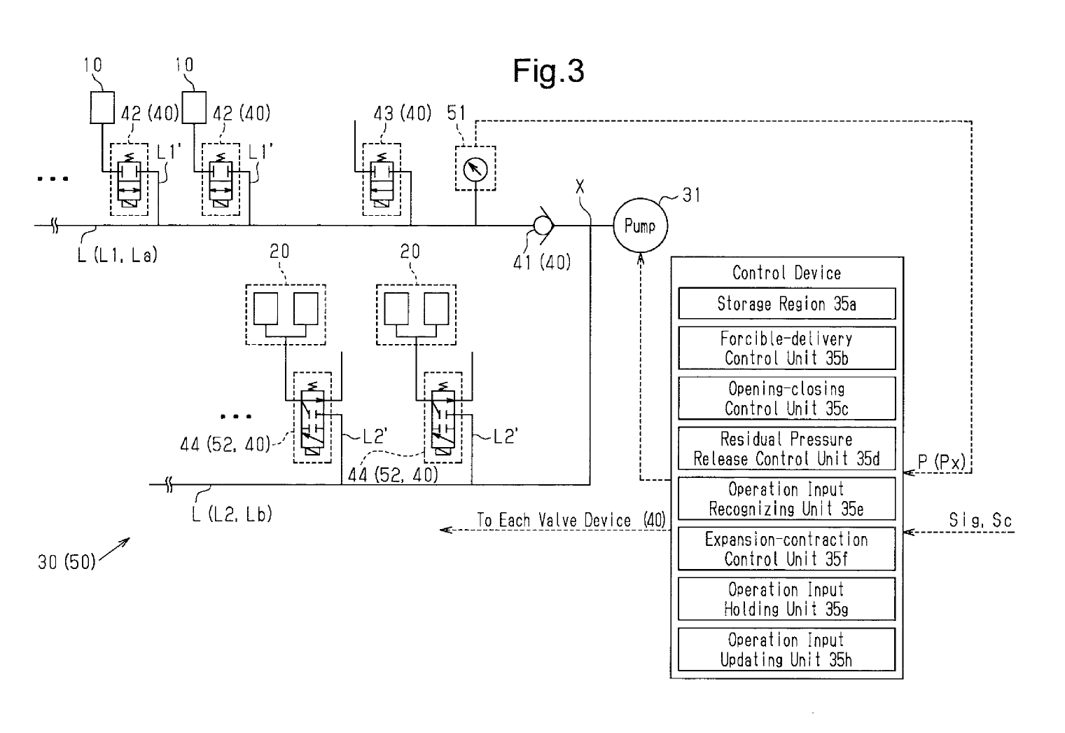

Additionally, as shown in FIG. 3, the seat device 30 of the present embodiment includes an air pump 31 that forcibly delivers air to each of the airbags 10 and 20. Further, passages L connecting the air pump 31 to each of the airbags 10 and 20 are provided with a plurality of valve devices 40 (41 to 44). In the seat device 30 of the present embodiment, activation of the air pump 31 and the valve devices 40 are controlled by a control device 35 (forcible-delivery control unit 35b).

More specifically, the seat device 30 of the present embodiment includes, as the passage L of an inlet-outlet device 50 constituted by the air pump 31 and the valve devices 40, a first passage L1 connecting each seat-support airbag 10 to the air pump 31 and a second passage L2 connecting each massage airbag 20 to the air pump 31. In the seat device 30 of the present embodiment, the second passage L2 branches from the first passage L1. Further, the first passage L1 is provided with a check valve 41 serving as the valve device 40. When the side corresponding to the air pump 31 of the first passage L1 is defined as an upstream side, the check valve 41 is located on the downstream side of a branch point X of the second passage L2. Each seat-support airbag 10 is in communication with the first passage L1 on the downstream side of the check valve 41.

In detail, in the seat device 30 of the present embodiment, each seat-support airbag 10 is connected to a branch line L1′ that branches from a main line La of the first passage L1. That is, in relation to each branch line L1′, the main line La of the first passage L1 is located on the upstream side regardless of the position. Further, each branch line L1′ is provided with an inlet valve 42 serving as the valve device 40. Further, the seat device 30 of the present embodiment includes an outlet valve 43 located on the downstream side of the check valve 41 in the first passage L1.

In the same manner, each massage airbag 20 is connected to a branch line L2′ that branches from a main line Lb of the second passage L2. That is, in relation to each branch line L2′, the main line Lb of the second passage L2 is located on the upstream side regardless of the position. Further, each branch line L2′ is provided with a three-way valve 44 serving as the valve device 40. The control device 35 (opening-closing control unit 35c) fills each of the airbags 10 and 20 with air (inlet) and releases the air filling each of the airbags 10 and 20 (outlet) by controlling the activation of each inlet valve 42 and the outlet valve 43, which are provided in the first passage L1, and each three-way valve 44, which is provided in the second passage, in accordance with the activation of the air pump 31.

In more detail, in the seat device 30 of the present embodiment, the first passage L1 is provided with a pressure sensor 51 on the downstream side of the check valve 41. The control device 35 of the present embodiment detects an internal pressure P of each seat-support airbag 10, which is connected to the first passage L1, based on an output signal of the pressure sensor 51.

More specifically, when detecting the internal pressure P of each seat-support airbag 10, the control device 35 opens the inlet valve 42 of the branch line L1′, which is in communication with the airbag 10 subject to the detection of internal pressure, with the outlet valve 43 in the first passage L1 closed. That is, the seat device 30 of the present embodiment is thus configured so that the internal pressure P of the airbag 10 subject to the detection is equal to an internal pressure Px of the first passage L1 provided with the pressure sensor 51. In addition, in the seat device 30 of the present embodiment, the detection of internal pressure using the pressure sensor 51 is performed with the inlet valve 42 open for a certain time. The control device 35 of the present embodiment performs averaging processing on the output signal of the pressure sensor 51 input during the time to reduce the influence of disturbance occurring when the vehicle is travelling and to accurately detect the internal pressure P of each airbag 10.

Further, the control device 35 of the present embodiment holds, in a storage region 35a, a target value (internal pressure target value P0) of the internal pressure P of each seat-support airbag 10. In the seat device 30 of the present embodiment, when the occupant sets an optimal support shape using an operation switch (not shown) provided on the seat 1, the internal pressure target value P0 of each airbag 10 is updated. For the detected internal pressure P of each airbag 10 to match the internal pressure target value P0, the control device 35 controls the activation of the air pump 31, the inlet valve 42, and the outlet valve 43.

More specifically, when filling each seat-support airbag 10 with air, the control device 35 of the present embodiment opens the inlet valve 42 provided on the branch line L1′ in communication with the airbag 10 subject to the air filling and drives the air pump 31 with the outlet valve 43 in the first passage L1 closed. When releasing the air from the airbag 10, the control device 35 opens the inlet valve 42 and the outlet valve 43 with the air pump 31 stopped.

The three-way valve 44, which is provided on each branch line L2′ of the second passage L2, is switchable between a first activation state and a second activation state. In the first activation state, the inflow of air from the upstream side of the three-way valve 44 to each massage airbag 20 and the outflow of air from each massage airbag 20 to the upstream side of the three-way valve 44 are both permitted. In the second activation state, the inflow and outflow of air between each airbag 20 and the second passage L2 is cutoff. Further, each three-way valve 44 can be switched to a third activation state that allows air filling each airbag 20 to be released to the outside in a state in which the inflow and outflow of air between each airbag 20 and the second passage L2 remains cut off. The control device 35 of the present embodiment expands and contracts each massage airbag 20 in a predetermined movement pattern by controlling the activation of each three-way valve 44 in a state in which the three-way valve 44 remains driven.

More specifically, in the seat device 30 of the present embodiment, the three-way valve 44 functions as an inlet valve 52 corresponding to each massage airbag 20. In relation to the second passage L2, the first activation state is an open state, and the second activation state and the third activation state are closed states.

In detail, when the control device 35 of the present embodiment identifies an airbag 20 undergoing expansion-contraction timing, i.e., an airbag 20 subject to control, based on the movement pattern of massage control, the control device 35 switches the three-way valve 44, which is provided on each branch line L2′ of the second passage L2 in communication with the airbag 20, to the first state. Thus, when air forcibly delivered from the air pump 31 is controlled to flow from the branch line L2′ of the second passage L2 into the airbag 20 through the three-way valve 44 serving as the inlet valve 52, the airbag 20 expands.

Subsequently, while keeping the air pump 31 in a driven state, the control device 35 switches the three-way valve 44 corresponding to the airbag 20 in the manner of the control. That is, this causes the three-way valve 44 serving as the inlet valve 52 and corresponding to the airbag 20 to be in the closed state in relation to the second passage L2. Thus, when control is performed for the air filling the airbag 20 to flow out instead of flowing to the upstream side of the three-way valve 44, the airbag 20 contracts.

More specifically, based on a preset movement pattern of the massage control, the control device 35 of the present embodiment sequentially switches each airbag 20 that is to be expanded and contracted. In the present embodiment, the time to expand the airbag 20 by keeping the three-way valve 44 in the first activation state and the time to contract the airbag 20 by keeping the three-way valve 44 in the third activation state are defined by a predetermined movement pattern. Further, the three-way valves 44 corresponding to other airbags 20 that are not part of the expansion-contraction timing are kept in the closed state in relation to the second passage L2. This allows the seat device 30 of the present embodiment to expand and contract only a particular airbag 20 that matches the expansion-contraction timing defined in the movement pattern in a state in which the air pump 31 remains driven.

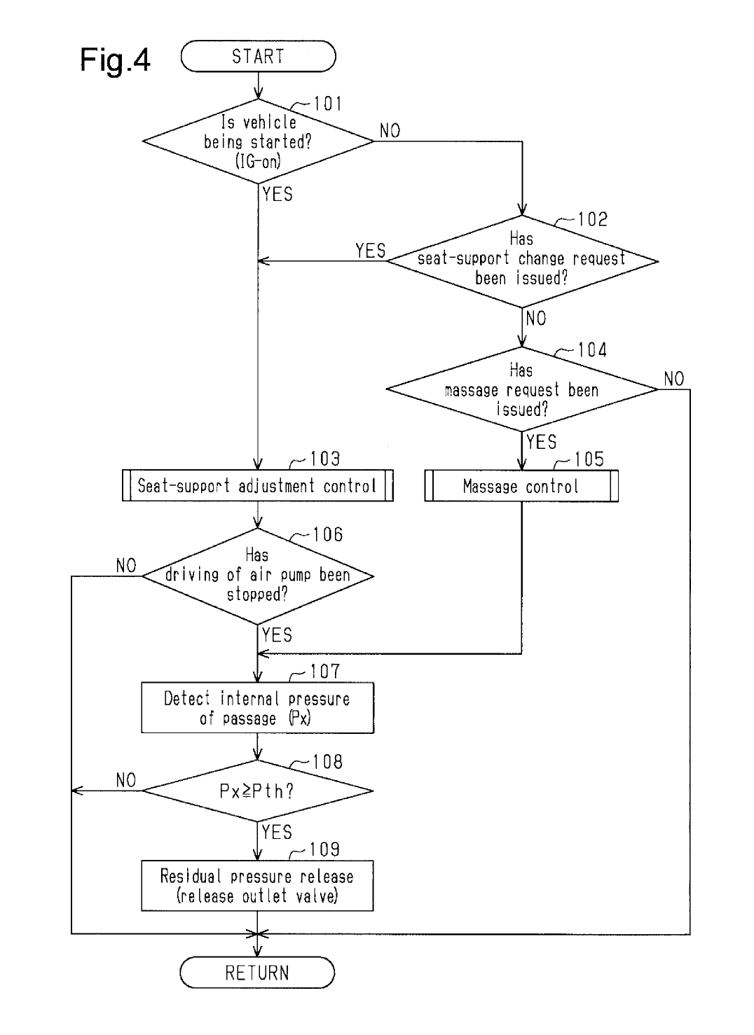

In more detail, as shown in the flowchart of FIG. 4, if the vehicle is being started (step 101: YES) or if an operation input for requiring the seat-support shape to change has been recognized (step 102: YES), the control device 35 (operation input recognizing unit 35e) of the present embodiment executes the control to expand and contract the seat-support airbag 10 (seat-support adjustment control, step 103). If an operation input for requiring a massage function of the seat 1 has been recognized (step 104: YES), the control device 35 (expansion-contraction control unit 35f) executes the control to expand and contract the massage airbag 20 (massage control, step 105).

The control device 35 of the present embodiment recognizes that the vehicle is being started based on an ignition signal Sig, which is input via a vehicle interior network (not shown). The control device 35 recognizes an execution request for the seat-support adjustment control and massage control based on an operation input signal Sc, which is input via the vehicle interior network (not shown) in the same manner.

Further, if the control device 35 of the present embodiment executes the seat-support adjustment control in step S103, the control device 35 subsequently determines whether the seat-support adjustment control is accompanied by driving of the air pump 31, i.e., forcibly-delivering of air through the passage L (L1) (step 106). In addition, if the control device 35 determines that the air pump 31 is driven in step 106 (step 106: YES), the control device 35 detects the internal pressure Px of the passage L connecting the air pump 31 to each of the airbags 10 and 20 (step 107). Then, the control device 35 determines whether the detected internal pressure Px of the passage L is greater than or equal to a predetermined threshold value Pth (step 108).

If the control device 35 executes the massage control in step 105, the control device 35 detects the internal pressure Px of the passage L in step 107 without executing step 106. Step 107 corresponds to a step of detecting the internal pressure of the passage L on the upstream side of the inlet valves 42 and 52 (44). In step 108, the control device 35 determines whether the detected internal pressure Px of the passage L is greater than or equal to the predetermined threshold value Pth.

Additionally, after executing the seat-support adjustment control of step 103 or the massage control of step 105, if the control device 35 of the present embodiment (residual pressure release control unit 35d) determines in step 108 that the internal pressure Px of the passage L is greater than or equal to the predetermined threshold value Pth (step 108: YES), the control device 35 opens the outlet valve 43 provided in the first passage L1 as described above. This causes air to be released from the passage L (residual pressure outlet, step 109). Step 109 corresponds to a step of releasing air sealed in the passage L from the passage L when the internal pressure of the passage L is greater than or equal to the predetermined threshold value.

More specifically, after executing the seat-support adjustment control and the massage control, the seat device 30 of the present embodiment sets all the closable valve devices 40 (42 to 44) other than the check valve 41, which are provided in the passage L (L1, L2), to the closed (fully-closed) state. Thus, even after the air pump 31 is stopped, the air forcibly delivered from the air pump 31 may be sealed in the passage L, more specifically, sealed on the upstream side of each valve device 40.

Based on this point, as described above, after the air pump 31 is stopped, the control device 35 of the present embodiment detects the internal pressure Px of the passage L and releases, to the outside, the air sealed in the passage L on the upstream side of the inlet valves 42 and 52 (44), which are respectively provided in the passages L (L1, L2), when the internal pressure Px is greater than or equal to the predetermined threshold value Pth. More specifically, the threshold value Pth used to determine the internal pressure is set to a value at which it is assumed that the residual pressure (the internal pressure Px) of the passage L may instantaneously expand (i.e., budge) the corresponding airbags 10 and 20 when each of the inlet valves 42 and 52 (44) is opened. Thus, the seat device 30 of the present embodiment is configured such that the airbags 10 and 20 are not budged by the residual pressure next time when the inlet valves 42 and 52 (44) are opened.

If the seat-support control executed earlier is not accompanied by driving of the air pump 31 in step 106 (step 106: NO), the control device 35 of the present embodiment does not execute the processes subsequent to step 107. More specifically, the drive recognizing determination for the air pump 31 is performed only when the seat-support control is executed because the seat-support control may be ended only by contracting the seat-support airbag 10 without driving the air pump 31 and forcibly delivering air to the airbag 10. Further, if the execution request for the massage control has not been recognized in step 104 (step 104: NO), the control device 35 does not execute the processes subsequent to step 105. If the detected internal pressure Px of the passage L is less than the predetermined threshold value Pth in step 108 (step 108: NO), the process of step 109 is not executed.

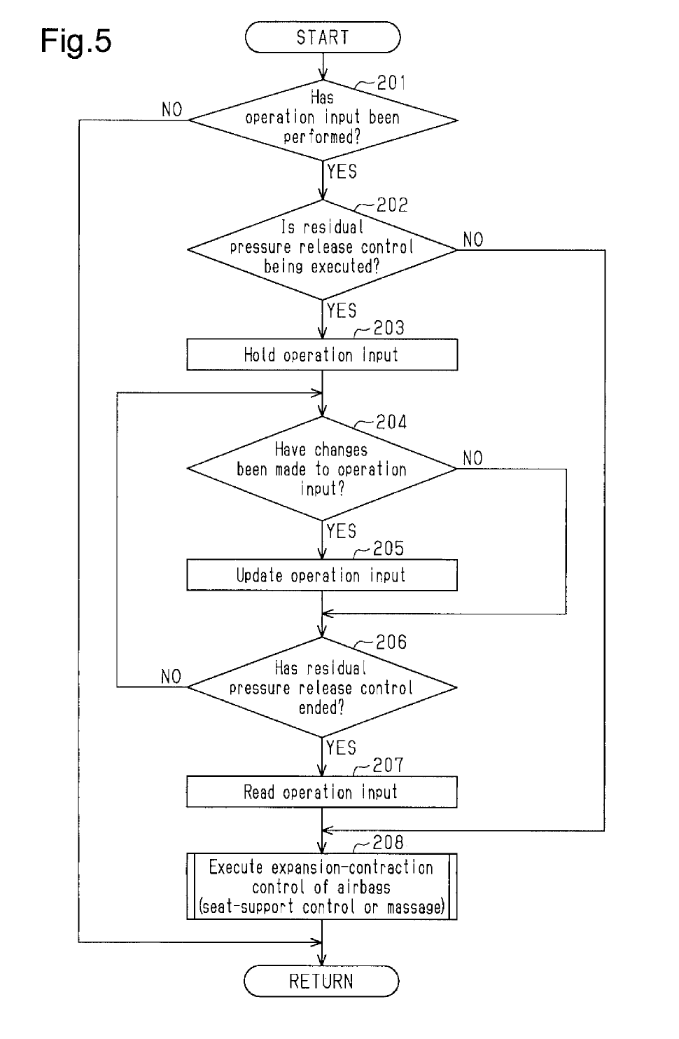

Further, as shown in the flowchart of FIG. 5, if the control device 35 of the present embodiment detects the generation of an operation input based on the operation input signal Sc (step 201: YES), the control device 35 first determines whether the above residual pressure release control is being executed (step 202). In the present embodiment, the operation input of the occupant for requiring execution of the seat-support adjustment control and the massage control is performed by “pressing and holding” an operation switch (not shown) provided on the seat 1. If the operation input has been performed during the execution of the residual pressure release control (step 202: YES), the control device 35 (operation input holding unit 35g) of the present embodiment holds, in the storage region 35a, the content of the operation input indicated in the operation input signal Sc (step 203).

Further, the control device 35 (operation input updating unit 35h) of the present embodiment determines whether changes have been made to the content of the operation input indicated in the operation input signal Sc (step 204). If changes have been made (step 204: YES), the control device 35 updates the content of the operation input held in the storage region 35a to the content of a new operation input indicated in the operation input signal Sc (step 205).

In addition, the control device 35 of the present embodiment determines whether the residual pressure release control determined as being executed in step 202 has ended (step 206). If it is determined that the residual pressure release control is still being executed (step 206: NO), the control device 35 repeats the processes of steps 204 to 206 until the residual pressure release control ends.

Afterwards, if the control device 35 of the present embodiment determines that the residual pressure release control has ended in step 206 (step 206: YES), the control device 35 reads the content of the operation input held in the storage region 35a (step 207). Based on the content of the operation input read from the storage region 35a, the control device 35 executes the expansion-contraction control of each of the airbags 10 and 20 provided in the seat 1, i.e., the seat-support adjustment control or the massage control (step 208; refer to steps 102 to 109 in FIG. 4).

If no change has been made to the content of the operation input indicated in the operation input signal Sc in step 204 (step 204: NO), the control device 35 of the present embodiment does not execute the process of step 205. In addition, if the control device 35 determines that the residual pressure release control is not being executed in step 202 (step 202: NO), the control device 35 does not execute the processes of steps 203 to 207. If the control device 35 determines that no operation input has been performed in step 201, the control device 35 does not execute the processes of steps 202 to 208.

(1) As described above, in the present embodiment, the residual pressure of air sealed on the upstream side of the inlet valves 42 and 52 (44), which are respectively provided in the passages L (L1, L2) in communication with the airbags 10 and 20 in the seat 1, prevents each of the airbags 10 and 20 from instantaneously expanding (i.e., budging) when the inlet valves 42 and 52 are opened. This allows for a more excellent usability.

(2) In particular, the expansion-contraction state of each seat-support airbag 10 is usually held to be constant with the occupant sitting in the seat 1. Expanding and contracting the airbag 10 in this state changes the support shape of the seat 1. This results in the feature in which the occupant sitting in the seat 1 easily feels each seat-support airbag 10 budging. Thus, the application of the present embodiment to each seat-support airbag 10 produces a more prominent effect.

(3) In addition, the internal pressure P is set to be high for each massage airbag 20 that presses the occupant from under the seat covering 1× when the airbag 20 expands. Thus, the application to each seat-support airbag 10 produces a more prominent effect.

(4) In addition, the control device 35 executes the residual pressure release control only when the internal pressure Px of the passage L is greater than or equal to the predetermined threshold value Pth (Px Pth). This limits the occurrence of delay caused by the execution of the residual pressure release control. This allows for a more excellent usability.

(5) In addition, the control device 35 holds, in the storage region 35a, the content of an operation input that should expand each of the airbags 10 and 20 received during the execution of the residual pressure release control. Thus, after the residual pressure release control ends, the expansion-contraction control of each of the airbags 10 and 20 can be executed smoothly and immediately. This allows for a more excellent usability.

The above-described embodiment may be modified as described below.

The number and arrangement of the airbags 10 and 20 provided in the seat 1 may be changed. The structure of the passage L connecting the air pump 31 to the airbags 10 and 20, the number and arrangement of the valve devices 40 provided in the passage L, and the configuration of the inlet-outlet device 50 may also be changed. That is, regardless of the configuration of the inlet-outlet device 50, when the air forcibly delivered from the air pump 31 may be sealed in the passage L on the upstream side of the closed inlet valve 42, the residual pressure release control of the above-described embodiment simply needs to be applied.

For example, in the above-described embodiment, the second passage L2 in communication with each massage airbag 20 branches from the first passage L1 in communication with each seat-support airbag 10. Further, the first passage L1 is provided with the check valve 41 on the downstream side of the branch point X of the second passage L2. In addition, the residual pressure release control is performed by opening the outlet valve 43, which is provided in the first passage L1 on the downstream side of the check valve 41.

Instead, for example, the first passage L1 and the second passage L2 may be provided independently. In this case, the residual pressure release control simply needs to be performed independently for the first passage L1 and the second passage L2. Additionally, the first passage L1 and the second passage L2 may be connected without being divided by the check valve 41, that is, each seat-support airbag 10 and each massage airbag 20 may share the passage L. In this case, the outlet valve 43 used for the residual pressure release control may be provided in any part of the passage L.

In the above-described embodiment, the residual pressure release control is executed when the internal pressure Px of the passage L is greater than or equal to the predetermined threshold value Pth (Px Pth) after the seat-support adjustment control that is accompanied by the driving of the air pump 31 or the massage control is executed.

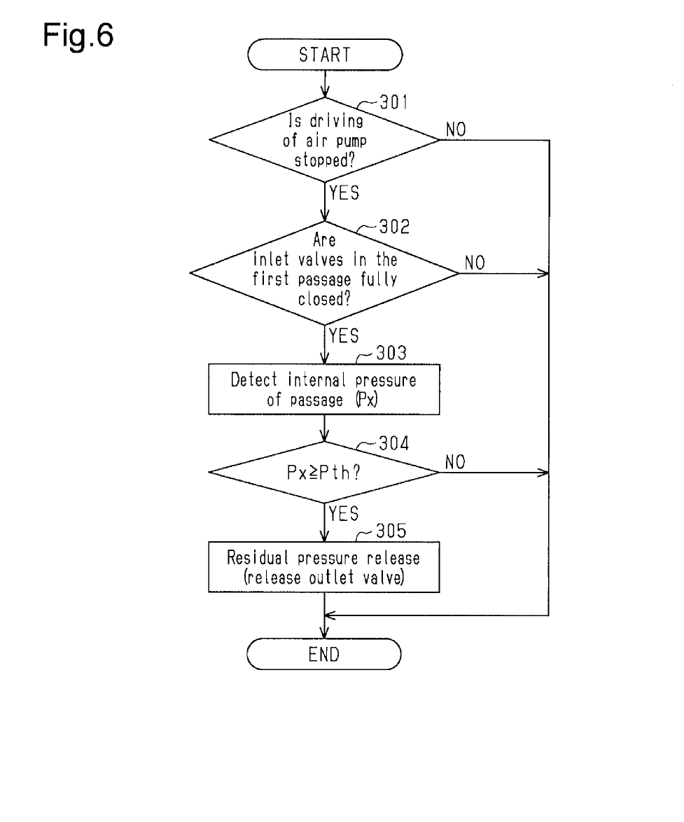

Instead, for example, as shown in the flowchart of FIG. 6, if stopping of the air pump 31 that was in a driven state is recognized (step 301: YES), it may be first determined whether all of the inlet valves 42 in the first passage L1 are closed (fully closed) (step 302). In this example, the processes subsequent to step 301 are the same as the processes subsequent to step 107 in FIG. 4 and thus will not be described.

More specifically, in a case in which the configuration is the same as that of the inlet-outlet device 50 in the seat device 30 of the above-described embodiment, when each inlet valve 42 provided in the first passage L1 in communication with the corresponding seat-support airbag 10 is fully closed, air may be sealed in the first passage L1 and the second passage L2. The fully-closed recognition limits the occurrence of delay caused by the execution of the residual pressure release control.

As another option, the residual pressure release control may be executed without detecting the internal pressure of the passage L or determining the closing operation of the valve system. This limits the budging of the airbags 10 and 20 with further reliability based on the residual pressure of air sealed in the passage L.

In the above-described embodiment, the seat device 30 is provided with the seat-support airbags 10 and the massage airbags 20. Instead, only one of the seat-support airbags 10 and the massage airbags 20 may be provided.

In the above-described embodiment and modification, the control device 35 includes the forcible-delivery control unit, the opening-closing control unit, the residual pressure release control unit, the operation input recognizing unit, the expansion-contraction control unit, and the operation input holding unit. However, each function control unit may be configured by a plurality of control devices.

The control device 35 is realized, for example, by at least one dedicated hardware circuit and/or at least one processor (control circuit) that operates in accordance with a computer program (software). That is, each of the control devices 35 is realized by an electronic control unit having circuitry that is programmed to execute desired procedures. The processor includes a CPU and memory, such as a RAM and ROM. The memory stores program codes or instructions configured to cause the processor to execute processes. The memory, or computer readable media, includes any type of media that are accessible by general-purpose computers and dedicated computers.

The storage region 35a may be any type of memory capable of temporarily storing data.

1. A pneumatic control device for a vehicle seat, comprising:
a forcible-delivery control unit that drives an air pump to forcibly deliver air to an airbag, the airbag being provided in a seat;
an opening-closing control unit that opens and closes an inlet valve, the inlet valve being provided in a passage of the air, wherein the passage is in communication with the airbag; and
a residual pressure release control unit that opens an outlet valve provided in the passage on an upstream side of the inlet valve after driving of the air pump is stopped, thereby releasing the air sealed on the upstream side of the inlet valve in a closed state from the passage.

2. The pneumatic control device according to claim 1, wherein the residual pressure release control unit
detects an internal pressure of the passage on the upstream side of the inlet valve, and
releases the air in the passage when the internal pressure of the passage is greater than or equal to a predetermined threshold value.

3. The pneumatic control device according to claim 1, wherein the airbag includes a support airbag that changes a support shape of the seat.

4. The pneumatic control device according to claim 1, wherein the airbag includes a massage airbag that presses an occupant from under a seat covering.

5. The pneumatic control device according to claim 1, comprising:
an operation input recognizing unit that recognizes an operation input;
an expansion-contraction control unit that controls activation of a valve device provided in the passage to expand and contract the airbag based on the operation input; and
an operation input holding unit that holds, in a storage region, the operation input recognized during execution of residual pressure release control for releasing the air sealed on the upstream side of the inlet valve from the passage.

6. The pneumatic control device according to claim 5, comprising an operation input updating unit that updates a content of the operation input held in the storage region when a change is made to the operation input held in the storage region.

7. The pneumatic control device according to claim 5, comprising a residual pressure release control unit that performs a control to expand and contract the airbag based on the operation input held in the storage region when the residual pressure release control has ended.

8. A pneumatic control method for a vehicle seat, comprising:
driving an air pump to forcibly deliver air to an airbag, the airbag being provided in a seat;
opening and closing an inlet valve, the inlet valve being provided in a passage of the air, wherein the passage is in communication with the airbag; and
opening an outlet valve provided in the passage on an upstream side of the inlet valve after driving of the air pump is stopped, thereby releasing the air sealed on the upstream side of the inlet valve in a closed state from the passage.

9. The pneumatic control method according to claim 8, further comprising:
detecting an internal pressure of the passage on the upstream side of the inlet valve; and
releasing the air sealed in the passage from the passage when the internal pressure of the passage is greater than or equal to a predetermined threshold value.
